(19) United States
(12) Patent Application Publication
(10) Pub. No.: US 2019/0180218 A1
(43) Pub. Date: Jun. 13, 2019

(54) METHODS AND SYSTEMS FOR AUTOMATED MULTI-USER TASK SCHEDULING

(71) Applicant: Einthusan Vigneswaran, Thorold (CA)

(72) Inventor: Einthusan Vigneswaran, Thorold (CA)

(21) Appl. No.: 16/193,033

(22) Filed: Nov. 16, 2018

Related U.S. Application Data
(60) Provisional application No. 62/597,592, filed on Dec. 12, 2017.

(51) Int. Cl. G06Q 10/06; H04W 4/02

(52) U.S. Cl. CPC G06Q 10/063116; H04W 4/02; G06Q 10/063114; G06Q 10/0633

(57) ABSTRACT

System and method for automatically scheduling tasks for multi-stage projects. A task scheduling server communicates with a plurality of mobile devices operating user applications. Each mobile device has a user profile associated with a user type. The task scheduling server receives a project request including project criteria and generates a project workflow using the project criteria. The workflow includes various required work stages and associated work stage completion deadlines. The server associates user types with the tasks for each work stage, and assigns users to those tasks based on user profiles, project location and user location. Assigned users are notified through the user application, and the assigned user is provided with work stage data indicating the project location, the at least one task associated with that work stage and the stage completion deadline. Users can validate completion of the assigned tasks through the user application.

### REFERENCE TO RELATED APPLICATIONS

This application claims the benefit of U.S. Provisional Application No. 62/597,592, filed on Dec. 12, 2017, which is incorporated by reference herein in its entirety.

### FIELD

The described embodiments relate to schedule optimization, and in particular to systems and methods for automatically scheduling tasks for multiple users.

### BACKGROUND

The following is not an admission that anything discussed below is part of the prior art or part of the common general knowledge of a person skilled in the art.

Overseeing ongoing projects can be a complex and time consuming task. Projects that take place over an extended period of time, such as weeks or months, may require persistent supervision to ensure tasks are completed correctly and on schedule. Multi-stage projects, particularly those in which later stages are dependent on the successful completion of earlier stages may require particularly close review and involvement to ensure they are completed on schedule. Such projects are common in household renovations, where a series of work stages are completed, often in sequence.

These projects may also require workers with different skills to participate and contribute to different stages of the project. The need for multiple workers may in turn increase the need for a human manager to monitor and ensure on-time task completion, as coordinating and scheduling appropriate workers can be a complex and dynamically changing task requiring years of experience and knowledge to accomplish successfully.

When multiple projects are undertaken simultaneously, the complexity of managing the projects increases substantially, and may be beyond the ability of even experienced individuals. Scheduling workers for different projects can be particularly difficult when specific skills or qualifications are required on multiple projects. Ensuring that the appropriate workers are available for the various stages of each project may require a manager or a team of managers to constantly monitor and update worker schedules. This may result in an inefficient allocation of work, for instance where a manager or managers allocate work preferentially. Managers of individual projects may also be unaware of a worker's schedule for other projects which can lead to delays caused by the unavailability of particular workers.

When overseeing projects at different locations it may also be difficult to oversee task completion to ensure that tasks are being completed properly. Managers may make infrequent random or periodic site visits to check that tasks are completed correctly, which nevertheless requires the use of a manager's limited available time traveling to and from work sites. This can be an ineffective oversight mechanism and may lead to delays in identifying and in turn rectifying errors if any are made. This can further compound the difficulty in scheduling a project.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

Various embodiments are described herein that generally relate to

In a broad aspect, there is provided a system for automatically scheduling tasks for multi-stage projects. The system can include a task scheduling server comprising a memory and a server processor coupled to the memory, the task scheduling server in communication with a plurality of mobile devices, each mobile device associated with a user having a user profile stored in the memory of the task scheduling server where each user profile has at least one associated user type; and a user application installed on each of the mobile devices; where the processor of the task scheduling server is configured to: receive a project request identifying a plurality of project criteria, the plurality of project criteria including a project location, a project timeframe and a work definition; generate a project workflow from the plurality of project criteria, the project workflow including a plurality of work stages required to complete the work requested and a work stage completion deadline determined based on the project timeframe, wherein each work stage includes at least one task; associate at least one required user type with each work stage based on the tasks included in that work stage; for each work stage, determine an assigned user by: identifying at least one potential user as a user whose user profile has an associated user type that corresponds to one of the required user types for the work stage; and selecting the assigned user from the at least one potential users based on a comparison of the project location and user location information received from the user application installed on the mobile device of each potential user; and transmit an assigned work stage notification to the mobile device of the assigned user through the user application, the assigned work stage notification indicating that the user has been assigned to the work stage and including work stage data indicating the project location, the at least one task associated with that work stage and the stage completion deadline.

In some embodiments, the processor of the task scheduling server is configured to: arrange the plurality of work stages into an ordered project schedule that is defined in accordance with the project timeframe, the ordered project schedule including a plurality of dependent stage relationships, each dependent stage relationships indicating that initiation of a second work stage is dependent upon at least partial completion of a first work stage; receive a first work completion notification from the mobile device of a first assigned user for the first work stage through the user application; and trigger transmission of the work stage notification to a second assigned user for the second work stage in response to the work completion notification.

In some embodiments, the second assigned user is determined after receiving the first work completion notification.

In some embodiments, the processor of the task scheduling server is configured to: receive validation data corresponding to the first work stage, the validation data providing evidence of completion of the first work stage by the first assigned user; and indicate that the first work stage is completed only after receipt of the validation data for the first work stage.

In some embodiments, wherein the user application includes instructions for configuring the processor of the mobile device of the first assigned user to: automatically monitor a location of the first assigned user during the first work stage to generate first user location data; and the validation data includes the first user location data.

In some embodiments, the validation data further comprises image data received from the mobile device of the first assigned user.

In some embodiments, the work stage notification for the second work stage further includes a validation instruction for the second assigned user, the validation instruction defining a validation task for the second assigned user to generate independent validation data indicating completion of the first work stage; and the processor of the task scheduling server is configured to receive the independent validation data from the second assigned user through the user application.

In some embodiments, the processor of the task scheduling server is configured to select the assigned user for a particular work stage by: determining a local subset of the potential users by comparing the project location to location information received from the user application installed on the mobile device of each potential user, the local subset including a plurality of local potential users with each local potential user having a user location that is within a local threshold proximity of the project location; transmitting a potential work stage notification to each local potential user; receiving at least one availability response, each availability response received from the user application on the mobile device of one of the local potential users and indicating that the corresponding local potential user is available; and selecting the assigned user from amongst the available local potential users.

In some embodiments, the plurality of project criteria include a plurality of weighting criteria, the plurality of weighting criteria including a timing weight, a cost weight, and a quality weight; each availability response includes a proposed cost and a proposed completion time for the particular work stage; and the processor of the task scheduling server is configured to select the assigned user by: determining, for each local potential user, a weighted user score based on the proposed cost, the proposed completion time, and user quality data stored in the user profile for that local potential user using the plurality of weighting criteria; and selecting the assigned user as the local potential user having the highest weighted score.

In some embodiments, the assigned user for each work stage is selected from the at least one potential users based on projected availability data associated with the potential users, the projected availability data determined based on the project workflows for a plurality of unrelated multi-stage home renovation projects scheduled by the server.

In another broad aspect, there is provided a method of automatically scheduling tasks for multi-stage projects. The method can include: providing a task scheduling server in communication with a plurality of mobile devices; storing, for each mobile device, a user profile associated with a user, the user profile including at least one associated user type; providing a user application for installation on each of the mobile devices; receiving, by the server, a project request identifying a plurality of project criteria, the plurality of project criteria including a project location, a project timeframe and a work definition; generating, by the server, a project workflow from the plurality of project criteria, the project workflow including a plurality of work stages required to complete the work requested and a work stage completion deadline determined based on the project timeframe, wherein each work stage includes at least one task; associating, by the server, at least one required user type with each work stage based on the tasks included in that work stage; for each work stage, determining, by the server, an assigned user by: identifying at least one potential user as a user whose user profile has an associated user type that corresponds to one of the required user types for the work stage; and selecting the assigned user from the at least one potential users based on a comparison of the project location and user location information received from the user application installed on the mobile device of each potential user; and transmitting, by the server, an assigned work stage notification to the mobile device of the assigned user through the user application, the assigned work stage notification indicating that the user has been assigned to the work stage and including work stage data indicating the project location, the at least one task associated with that work stage and the stage completion deadline.

In some embodiments, the method may include arranging, by the server, the plurality of work stages into an ordered project schedule that is defined in accordance with the project timeframe, the ordered project schedule including a plurality of dependent stage relationships, each dependent stage relationships indicating that initiation of a second work stage is dependent upon at least partial completion of a first work stage; receiving, by the server, a first work completion notification from the mobile device of a first assigned user for the first work stage through the user application; and triggering transmission of the work stage notification to a second assigned user for the second work stage in response to the work completion notification.

In some embodiments, the server determines the second assigned user after receiving the first work completion notification.

In some embodiments, the method may include receiving, by the server, validation data corresponding to the first work stage, the validation data providing evidence of completion of the first work stage by the first assigned user; and indicating that the first work stage is completed only after receipt of the validation data for the first work stage.

In some embodiments, the method may include automatically monitoring by the user application a location of the mobile device of the first assigned user during the first work stage to generate first user location data; and receiving, by the server as part of the validation data for the first work stage, the first user location data from the user application.

In some embodiments, the method may include receiving, by the server, image data from the mobile device of the first assigned user as part of the validation data.

In some embodiments, the method may include transmitting, by the server, a validation instruction for the second assigned user in the work stage notification for the second work stage further, the validation instruction defining a validation task for the second assigned user to generate independent validation data indicating completion of the first work stage; and receiving, by the server, the independent validation data from the second assigned user through the user application.

In some embodiments, the assigned user for a particular work stage is selected by the server by: determining a local subset of the potential users by comparing the project location to location information received from the user application installed on the mobile device of each potential user, the local subset including a plurality of local potential users with each local potential user having a user location that is within a local threshold proximity of the project location; transmitting a potential work stage notification to each local potential user; receiving at least one availability response, each availability response received from the user application on the mobile device of one of the local potential users and indicating that the corresponding local potential user is available; and selecting the assigned user from amongst the available local potential users.

In some embodiments, the plurality of project criteria include a plurality of weighting criteria, the plurality of weighting criteria including a timing weight, a cost weight, and a quality weight; each availability response includes a proposed cost and a proposed completion time for the particular work stage; and the assigned user is selected by the server by: determining, for each local potential user, a weighted user score based on the proposed cost, the proposed completion time, and user quality data stored in the user profile for that local potential user using the plurality of weighting criteria; and selecting the assigned user as the local potential user having the highest weighted score.

In some embodiments, the assigned user for each work stage is selected by the server from the at least one potential users based on projected availability data associated with the potential users, the projected availability data determined based on the project workflows for a plurality of unrelated multi-stage home renovation projects scheduled by the server.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a block diagram of a task scheduling system in accordance with an example embodiment;

FIG. 2 is a block diagram showing a task scheduling server and user device for the task scheduling system of FIG. 1 in accordance with an example embodiment;

FIG. 3 is a flowchart illustrating a method of automatically scheduling multi-stage projects in accordance with an example embodiment;

FIG. 4 is a flowchart illustrating a method of generating a project workflow in accordance with an example embodiment;

FIG. 5 is a flowchart illustrating a method of determining an assigned user for a work stage in accordance with an example embodiment;

FIG. 6 is a flowchart illustrating another method of determining an assigned user for a work stage in accordance with an example embodiment;

FIG. 7 is a flowchart illustrating a sub-process of selecting an assigned user in accordance with an example embodiment;

FIG. 8 is a flowchart illustrating a method of validating the completion of a work stage in accordance with an example embodiment;

FIG. 9 is a flowchart illustrating a method of generating a project request in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXEMPLARY EMBODIMENTS

Various systems or methods will be described below to provide an example of an embodiment of the claimed subject matter. No embodiment described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an embodiment that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming. Accordingly, the program code may be written in C, C++ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage.

Embodiments of the systems and methods described herein may provide systems and methods for multi-user task scheduling. In particular, the systems and methods described herein may facilitate optimization of worker schedules for multi-stage projects. The systems and methods described herein may also facilitate scheduling for multiple projects concurrently. The embodiments described herein may provide a centralized system that is configured to automatically optimize the division, scheduling, allocation, and completion of tasks by a plurality of independent performers.

A task scheduling server may be provided that communicates with a plurality of mobile devices. The mobile devices may correspond to performer users who may be available to perform project tasks (i.e. performer devices). In some cases, each mobile device may have installed thereon a user-side task scheduling application. Alternatively, the server may provide a web-based user-side application that is accessible to users of the mobile devices.

The performer associated with each mobile device can establish a user profile with the task scheduling server. The user profile may include a plurality of performer characteristics, such as a user type associated with the performer. The user type may define various tasks that the user is capable of performing or qualified to perform. The task scheduling server may also store additional data in the user profile for each performer, such as historical user data like previous projects participated in, task completion data, such as task duration, successful completion rate, client-generated scores etc.

The mobile devices may also include one or more client devices. Each client device can correspond to a client associated with a project. The client device may access the client-side task scheduling application to perform various functions such as generating and transmitting project requests and monitoring the status of existing projects. The client-side task scheduling application may be the same as user-side application accessed by performer users, although different functionality may be provided depending on the user accessing the application.

A project request generally includes project criteria defining the work required for the project. In response to receiving a project request, the task scheduling server can generate a project workflow based on the project criteria defined in the project request. The project workflow provides the basis for the server to automatically optimize the project schedule. The project workflow typically includes a plurality of work stages determined from the work defined by the project criteria. The server also defines or identifies one or more required user types associated with each work stage. The required user types identify types of users who would be suitable to carry out the tasks associated with a particular work stage.

The task scheduling server can also generate a project schedule that includes the plurality of work stages arranged into an estimated project timeline. The estimated project timeline may include one or more parallel sub-timelines. The project timeline and sub-timelines can be defined based on dependent stage relationships that define how individual work stages are dependent on one another (e.g. when a particular stage must be completed before a subsequent, dependent stage can begin). Accordingly, work stages that may be completed independent from one another may be scheduled to occur simultaneously or during an overlapping time period.

The task scheduling server can then assign one or more performer users to each of the work stages. The task scheduling server may determine the assignment of work stages using user data stored in the user profiles such as the user types associated with each performer. The task scheduling server can also be configured to monitor real-time location data and availability data generated by the user-side application on the performer devices. The mobile devices of each performer may continually or intermittently communicate with the task scheduling server to transmit location and/or availability data to the task scheduling server. The user-side application can also be configured to receive notifications of potential work tasks and assignments of work tasks.

When the task scheduling server assigns a user to a work stage, a work stage notification can transmitted to the mobile device associated with that user. The work stage notification can include work stage data such as the task or tasks required, and a required performance period. In some cases, an active work stage notification may be sent to the performer device at the initiation of the performance period in addition to the work stage notification. The active work stage notification may include additional work stage details such as the location of the project that may have been initially hidden from the user.

The user can then perform the task. When the task is completed, the user can transmit a work stage completion notification to the task scheduling server using the user-side application. The task scheduling server may then initiate a subsequent work stage, for instance, by transmitting an active work stage notification to a user assigned to the subsequent work stage.

In some cases, the task scheduling server may require validation data to ensure that a work task is completed successfully. For example, the user-side application may automatically monitor a user's location and other activities during the performance period of a work stage. The user-side application can transmit this location information to the task scheduling server to validate the user's presence at the project location during the performance period. The monitored location information can be used by the server to determine an on-site time period for the user. The on-site time can be compared to an estimated work stage period to provide an on-site time validity indicator.

The task scheduling server may also request additional validation data be captured and input by performers through their mobile device. For instance, a user may capture an image of a completed work task. The user-side application can transmit that image to the task scheduling server as a portion of the validation data. The user-side application may also tag the image with location information (e.g. acquired from GPS or cellular location data) and/or an image time to provide further validation data.

In some cases, the server may require independent validation of work stage completion. For example, the task scheduling server may include validation instructions in a work stage notification for the subsequent stage. The validation instructions may direct the user assigned to the subsequent stage to capture validation data such as images of the completion of the previous task prior to beginning the subsequent task.

In some cases, the server may assign users to the work stages in a real-time assignment process. The server may identify, in real-time, users who are within a defined vicinity of the project location (e.g. 10 km or 25 km for example) and who are available to perform the task or tasks for that work stage.

The task scheduling server may transmit an available work stage notification to nearby performer devices corresponding to users whose user type matches the required user type for the work task to be assigned. The users may then indicate their availability through their performer devices. The server can then assign the work stage to nearby available users that have confirmed their availability.

In some cases, the server can select the assigned user(s) from the nearby available users by determining a weighted user score. The weighting user score can be determined using weighting criteria such as distance to project, user rating (which may itself be a score defined based on data stored in the user profile), expected time, expected cost, etc. In some cases, a client user may adjust the criteria weights to be applied for a particular project so that certain criteria (e.g. time) are deemed more or less important (i.e. given greater weight) than others (e.g. cost).

In some cases, a subset of nearby and available users may be display on the client device to allow a client user to select one or more particular performer users. The server may also provide the client user with access to user profile data, such as ratings and reviews generated by previous clients, prior to selecting the assigned user(s) for the work stage. Alternatively, the performer or performers may be selected automatically by the server based on the weighted score.

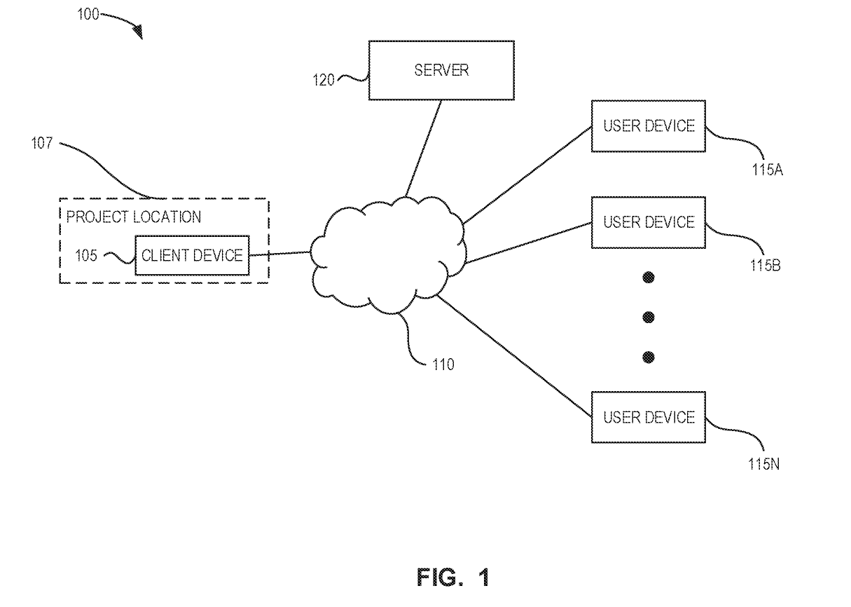

Referring now to FIG. 1, there is provided is a block diagram of a task scheduling system 100 in accordance with an example embodiment. System 100 is an example of a system that may be used for automatically scheduling multi-stage projects.

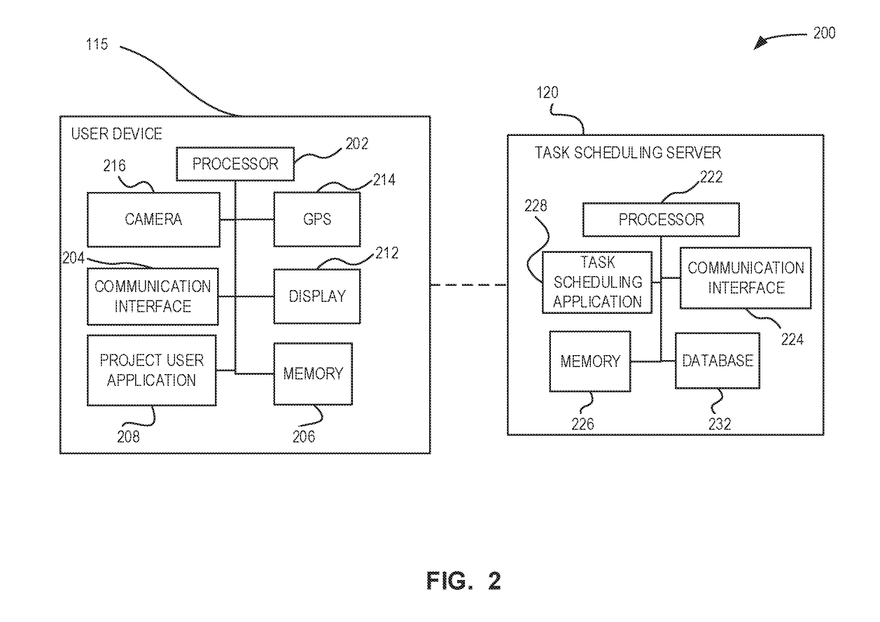

Task scheduling system 100 generally comprises a plurality of computers connected via data communication network 110, which itself may be connected to the Internet. In general, however, the computer network system includes a task scheduling server 120, a client user device 105 and a plurality of performer user devices 115A-115N connected via network 110. The performer user devices 115A-115N may typically be mobile devices. The client user device 105 may also be a mobile device similar to user devices 115, however the client device 105 can also be other computers such as a desktop computer. The task scheduling server 120 and performer devices 115 are described in greater detail with reference to FIG. 2 below.

Typically, the connection between network 110 and the Internet may be made via a firewall server (not shown). In some cases, there may be multiple links or firewalls, or both, between network 110 and the Internet. Some organizations may operate multiple networks 110 or virtual networks 110, which can be internetworked or isolated. These have been omitted for ease of illustration, however it will be understood that the teachings herein can be applied to such systems. Network 110 may be constructed from one or more computer network technologies, such as IEEE 802.3 (Ethernet), IEEE 802.11 and similar technologies.

Computers and computing devices may be connected to network 110 or a portion thereof via suitable network interfaces. Computing devices may also encompass any connected or “smart” devices capable of data communication, such as thermostats, air quality sensors, industrial equipment and the like. Increasingly, this encompasses a wide variety of devices as more devices become networked through the “Internet of Things”. In some cases, one or more of the computing devices such as the performer devices 115 and/or client device 105 may connect to network 110 via the Internet.

Examples of computers include the task scheduling server 120, such as a desktop or server computer, which can connect to network 110 via a wired Ethernet connection or a wireless connection. The task scheduling server 120 may also connect to the network 110 via the Internet. Task scheduling server 120 has a processor, volatile memory and non-volatile storage memory, and at least one network interface. The task scheduling server 120 may also include input devices such as a keyboard and trackpad, output devices such as a display and speakers, and various other input/output devices as will be appreciated. As with all devices shown in computer network system 100, there may be multiple servers 120, although not all are shown.

Similarly, client device 105 may also be a computer, such as desktop or laptop computer. In some instances, the client device 105 may be a portable or mobile device such as a smartphone or tablet. The client device 105 may be associated with a project location 107. That is, the client device 105 may correspond to a client who has requested that a project be undertaken at the project location 107. Accordingly, task scheduling server 120 may communicate with the client device 105 in regard to the project at project location 107.

Similarly, performer devices 115 generally refer to a smartphone or tablet computer, however performer devices 115 may also include a wide variety of “smart” devices capable of data communication such as an Apple™ Watch. As with server 120, performer devices 115A-115N have a processor, memory including volatile and non-volatile memory, at least one network interface, and input/output devices such as a display, keyboard and/or touchscreen, and a camera. Performer device 115 is typically portable, and may at times be connected to network 110 or a portion thereof.

The performer devices 115A-115N may be associated with performer users who may perform tasks associated with one or more projects scheduled by server 120. In general, similar devices may be used for client devices 105 and performer devices 115, although the required functionality may differ in some instances (e.g. performer devices 115 typically require real-time location information to be monitored, whereas client devices 105 may not).

Each of the computers and computing devices may at times connect to external computers or servers via the Internet. For example, server 120 may connect to a software update server to obtain the latest version of a software application or firmware. Similarly, devices 105 and 115 may connect to a software update server to obtain the latest versions of project user applications installed thereon.

As used herein, the terms “software application” or “application” refer to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled.

The software application may be associated with an application identifier that uniquely identifies that software application. In some cases, the application identifier may also identify the version and build of the software application. Within an organization, a software application may be recognized by a name by both the people who use it, and those that supply or maintain it. Mobile applications or “apps” generally refers to software applications for installation and use on mobile devices such as smartphones and tablets or other “smart” devices.

Referring now to FIG. 2, there is shown a block diagram of a task scheduling system 200. The task scheduling system 200 is a simplified illustration of task scheduling system 100, in which a task scheduling server 120 is shown in communication with a performer user device 115. However, it will be understood that system 200 can include a plurality of performer user devices 115, as well as one or more client user devices 105 in communication with the task scheduling server 120. The task scheduling server 120 may be linked to the user devices 115 via network 110 or, in some cases, the Internet.

Task scheduling server 120 has a processor 222, a memory 226, a communication interface 224 and a database 232. Although shown as separate elements, it will be understood that database 232 may be stored in memory 226.

Processor 222 is a computer processor, such as a general purpose microprocessor. In some other cases, processor 222 may be a field programmable gate array, application specific integrated circuit, microcontroller, or other suitable computer processor.

In some instances, the processor 222 may also be coupled to a display, which can be a suitable display for outputting information and data as needed by various computer programs. In particular, the display may display a graphical user interface (GUI). In some cases, the display may be omitted from task scheduling server 120, for instance where the task scheduling server 120 is configured to operate autonomously. In such cases, the task scheduling server 120 may be configurable using a computer such as a user device 115 or another computer that is connected to the task scheduling server 120. Task scheduling server 120 may execute an operating system, such as Microsoft Windows™, GNU/Linux, or other suitable operating system.

Communication interface 224 is one or more data network interface, such as an IEEE 802.3 or IEEE 802.11 interface, for communication over a network.

Processor 222 is coupled, via a computer data bus, to memory 226. Memory 226 may include both volatile and non-volatile memory. Non-volatile memory stores computer programs consisting of computer-executable instructions, which may be loaded into volatile memory for execution by processor 222 as needed. It will be understood by those of skill in the art that references herein to task scheduling server 120 as carrying out a function or acting in a particular way imply that processor 222 is executing instructions (e.g., a software program) stored in memory 226 and possibly transmitting or receiving inputs and outputs via one or more interface. Memory 226 may also store data input to, or output from, processor 222 in the course of executing the computer-executable instructions. As noted above, memory 226 may also store database 232.

In some example embodiments, database 232 is a relational database. In other embodiments, database 232 may be a non-relational database, such as a key-value database, NoSQL database, or the like. The database 232 may be used to store information usable by task scheduling server 120, such as user profiles associated with the user device 105 and user devices 115A-115N. The database 232 may also store project data, such as project workflows and user assignments, corresponding to projects scheduled by the server 120.

A performer user associated with a user device 115 can have a user profile stored in the database 232. The user profile associated with a user device 115 may be referred to as a performer or worker user profile. Similarly, a client associated with a client device 105 may also have a profile stored on the database 232. The user profile associated with a user device 105 may be referred to as a client user profile.

Each user profile stored in the database 232 may include user data associated with the corresponding user of user device 115 or 105. For instance, the user data may include demographic data such as the user's age, sex, general geographic region etc. The general geographic region data may include task location data indicating locations in which a performer is available to perform tasks. In some cases, the task location data may be generated by the performer, for instance by defining an available task region through user-side application 208. In some cases, the task location data may be generated or modified by the task scheduling server 120, for instance by monitoring location data from the user device 115. The server 120 may also update the general geographic region for each user automatically based on received task location data to reflect regions within which that user has previously performed tasks.

The user profiles stored in database 232 can also include user payment data to facilitate payments to and/or from a particular user. For instance, the user payment data stored in a performer user profile may be used to pay the corresponding user for successful completion of work tasks. The user payment data stored in a client user profile may be used to process payments from the client for completion of various work stages and/or projects.

The user data may also include one or more user types for the user. The user types associated with a performer user may define one or more types or categories of tasks that the performer is capable of performing or executing. The user types stored in the user profiles can be used by the task scheduling server 120 to identify performer users who are suitable to be assigned work tasks in the appropriate task categories.

For example, in the context of task scheduling for a home renovation project, one performer may have an associated flooring user type. The flooring user type may indicate that the user is capable of undertaking project tasks related to removing, replacing and/or installing flooring. In some cases, a user may be associated with multiple user types. This may define various different task categories for which the user is capable of undertaking tasks.

In some cases, the user types may further include user sub-types. For instance, a user profile may include a user type of flooring and related user types of laminate flooring and hardwood flooring. This may provide a more granular definition of tasks the user is capable of performing. It will be appreciated, however, that varying levels of user type granularity may be used in different embodiments of the systems and methods described herein.

In some cases, a user may be required to validate a particular user type in their user profile. This may be the case, for instance, where specialized training or certification is required to perform the related work tasks (e.g. electricians, plumbers). Accordingly, the user may be required to transmit evidence of the requisite certification or training to the server 120 prior to having that user type stored in their user profile.

The user profiles stored in the database 232 may also include historical user data. The historical user data can be used by the task scheduling server 120 to determine the assignment of work tasks to performers. The historical user data may include historical performance data associated with previous tasks performed by a user. The historical performance data can include automatically generated performance data, such as previous tasks completed, task duration data indicating the typical length of time required to complete a tasks, successful completion ratio/percentage indicating the proportion of completed tasks that were validated as being successfully completed, on-site time data indicating the proportion of time at a project location during the performance of a task and so forth.

In some cases, the historical performance data for a performer user can also include user-generated performance data. The user-generated performance data may be generated by a client user associated with user device 105 and/or a performer user. The user-generated performance data can include a performance score indicating the client user's satisfaction with a task completed by the performer user.

In some cases, the client user may generate the performance score without knowing the particular performer involved. For example, the client user may be unaware who the particular performer user or users were who completed one or more tasks. A client user may provide a performance score in respect of the task completion. The task scheduling server 120 may then associate the received performance score with the user or users who performed that particular task. In some cases, the user-generated performance data may also include additional performance details such as user-generated comments from a client user.

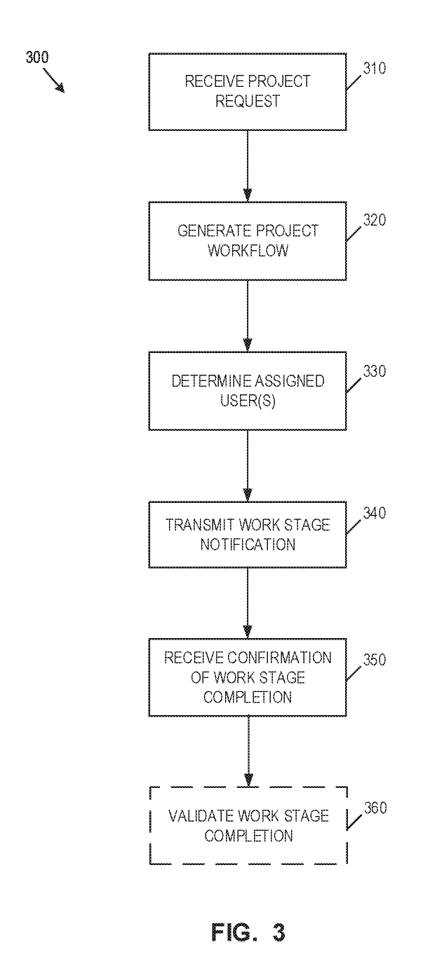

The memory 226 on task scheduling server 120 may store a software application referred to herein as a task scheduling application 228. The task scheduling application 228 may be configured to determine work stages associated with a project request received from a user device 105, and to generate a project work flow. The task scheduling application 228 may also be configured to assign users to various work stages within the project work flow and communicate with user devices 115 to disseminate task information and instructions, as well as monitor and validate the completion of various work tasks. The task scheduling application 228 may access data stored in the database 232, such as the user profiles, as part of its task scheduling functions. The task scheduling application 228 can be configured to perform various processed for scheduling multi-stage projects, such as the processes described herein below with reference to FIGS. 3-9.

Mobile device 115 is generally a mobile computer such as a smartphone or tablet or other “smart” device that may be networked through the “Internet of Things”. Mobile device 115 has a processor 202, a communication interface 204 for data communication with communication interface 224, a memory 206 that may include both volatile and non-volatile elements, a display 212, a GPS 214 and a camera 216. As with task scheduling server 120, references to acts or functions by mobile device 115 imply that processor 202 is executing computer-executable instructions (e.g., a software program) stored in memory 206.

For instance, a user-side application 208 may be stored on the mobile device 115. Although shown separately from memory 206, it will be understood that project user-side application 208 may be stored in memory 206. The user-side application 208 may communicate with the task scheduling application 228 of task scheduling server 120 to assist the task scheduling server 120 in assigning work tasks and monitoring the completion/validation of work tasks. The user-side application 208 can also enable performers to access and perform tasks related to projects scheduled by the server 120. The user-side application 208 may also be configured to enable the client devices 105 to define project criteria and generate project request when used on client devices 105.

The user-side application 208 may monitor user location data using location-based functions of mobile device 115 such as the GPS 214 or cellular-based location data. The user-side application 208 may transmit the user location data to the task scheduling server 120 on an ongoing or intermittent basis. In some cases, the user-side application 208 may store the user location data on memory 206 until such time as the user location data (or a portion thereof) is requested by the task scheduling server 120. The user-side application 208 may also associate the user location data with a timestamp to permit the task scheduling server 120 to reconstruct a location timeline for a user of the device 115.

To enable the user-side application 208 and project server 120 to effectively schedule projects, a user may be required to provide the user-side application with permissions to use features of the mobile device 115, such as the GPS 214 (or other location services) and camera 216. A user may be prevented from performing tasks scheduled by the server 120 if the corresponding permissions are not provided to the user-side application 208.

The user-side application 208 may also access data generated by the camera 216 on user device 115. The user-side application 208 may prompt the user of user device 115 to capture data using the camera 216. For example, the task scheduling server 120 may transmit a validation instruction to the user device 115. The user-side application 208 may generate a user prompt in response to the validation instruction. The prompt may indicate that validation data is to be captured using camera 216. The user can then select the prompt and capture the validation data. The user-side application 208 can transmit the validation data to task scheduling server 120 to validate the completion of a work task.

The task scheduling server 120 and mobile device 115 may have various additional components not shown in FIG. 2. For example, additional input or output devices (e.g., keyboard, pointing device, etc.) may be included beyond those shown in FIG. 2.

The user-side application 208 may be a mobile application provided by the task scheduling server 120. A user of the mobile device 115 may download the user-side application 208 from task scheduling server 120 or through an app store such as the Apple App Store™ or Google Play™.

When a user first accesses the user-side application 208, application 208 may prompt the user to create a user profile on the task scheduling server 120. The user may input various aspects of the user data, such as demographic data and user types into the user profile. The user profile may then be stored in the database 232.

The user devices 105 shown in FIG. 1 may generally correspond to the user devices 115 as described herein above. In some cases, the user-side application 208 for client user devices 105 may differ from the user-side application 208 for the performer user devices 115. Alternatively, the same user-side application 208 may be installed or accessed on client user devices 105 and performer user devices 115, although different functionality may be engaged depending on the user profile associated with user device 105 and user device 115.

A client user of client device 105 may also establish a client user profile on the task scheduling server 120. The client user profile may include demographic data similar to the performer user profile. The client user profile may also include project data related to projects requested by the client user. The project data may include past project data, ongoing project data, and requested project data related to projects that have not yet been initiated.

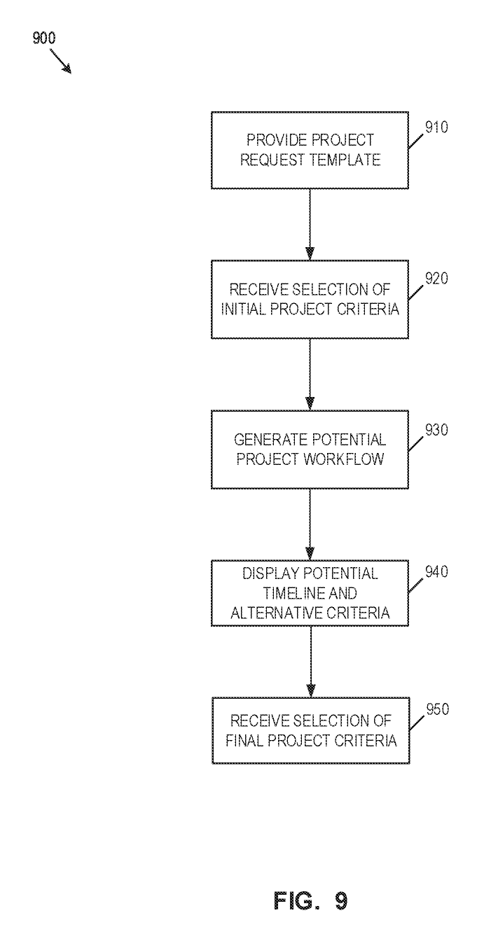

The client device 105 may transmit a project request to the task scheduling server 120 using the user-side application 208. An example of a process for generating a project request is described in further detail below with reference to FIG. 9. The project request can include project criteria defining the work required for the project. The project request can also include project location data which may define the project location 107 associated with the client device 105. A user of the client device 105 may also access the project data stored on the task scheduling server 120 using the user-side application 208 to monitor the status of the project. In some cases, the client device 105 may also provide user input to various aspects of the project such as selecting a performer or performers for one or more work stages.

Referring now to FIG. 3, shown therein is a flowchart illustrating a method or process 300 of automatically scheduling a multi-stage project. Method 300 may be carried out by various components of systems 100 and 200, such as the server 120 and the user devices 115.

At 310, the task scheduling server 120 can receive a project request. The project request can include a plurality of project criteria such as a project location, a project timeframe and a work definition. In some cases, the project request may also include task scheduling data, such as weighting criteria and criteria weights that the server 120 can use to assign users to work tasks.

The project request may be received from a client device 105. For example, a client user may access the user-side application 208 on client device 105 and define a set of project criteria. The client device 105 can then transmit the criteria to the server 120. An example process for generating a project request is described in further detail herein below with reference to FIG. 9.

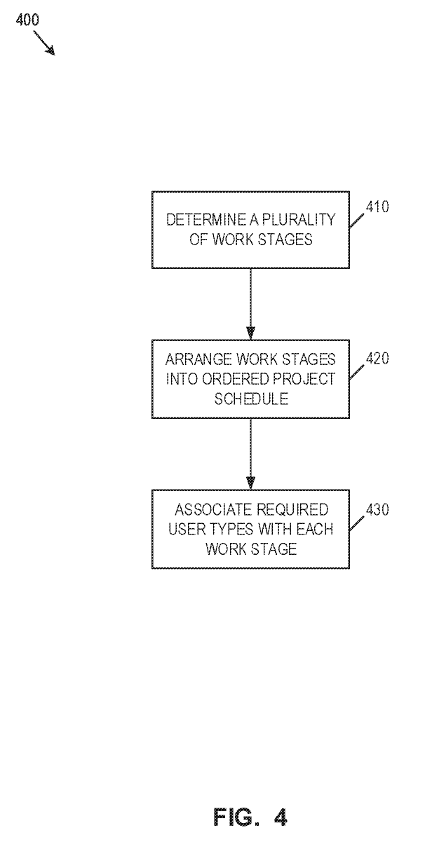

At 320, the server 120 can generate a project workflow based on the project request received at 310. For example, the server 120 may identify a plurality of work stages from the work definition in the project request. The server 120 can then generate the project work flow to include the plurality of work stages required to complete the work requested. An example process for generating a project workflow is described in further detail herein below with reference to FIG. 4.

The server 120 can also determine one or more tasks required to complete each work stage. A task generally refers to an action or set of actions that one or more assigned users must undertake in order to complete the work stage. For example, a work stage in which flooring is replaced at a project location may include multiple tasks such as, remove flooring, install sub-flooring, installing flooring etc.

The server 120 can also determine one or more required user types that correspond to each of the work stages. The server 120 may determine the required user types that correspond to a work stage by identifying user types capable of completing the tasks within that work stage. Accordingly, the server 120 may associate at least one required user type with each work stage based on the tasks included in that work stage.

In some cases, the server 120 may determine that multiple user types may be suitable for performing the tasks associated with a particular work stage. A user may be capable of the performing the tasks for the work stage if their associated user type corresponds to one of those required user types. In some cases, the required user types may be more or less suitable for the tasks associated with a particular work stage. Accordingly, the server 120 may also define a user type match score for each of the required user types associated with a work stage. The server 120 may use the user type match score as part of a process for determining which users to assign to a particular work stage.

The server 120 can also determine a work stage completion deadline based on the project timeframe in the project request. The server may determine the work stage completion deadline for each of the work stages so that the project workflow is constrained to be completed within the project timeframe. The work stage completion deadline for a particular work stage may be determined based on an expected time range for each task that corresponds to that work stage. The server 120 may determine the expected time range based on the time required for a corresponding work stage in previous projects.

In some cases, as explained below with reference to FIG. 9, the server 120 may also provide alternative criteria for adjusting the project timeframe or work definition based on the project workflow. This may enable a client user to adjust the project request based on the real-time location and availability of performers.

At 330, the project server 120 can determine one or more users to be assigned to each work stage in the project workflow defined at 320. In general, the server 120 can determine an assigned user by identifying at least one potential user whose user profile has an associated user type that corresponds to one of the required user types for the work stage. The server 120 may compare the required user types determined at 320 to the user profiles stored in database 232 to identify the at least one potential users.

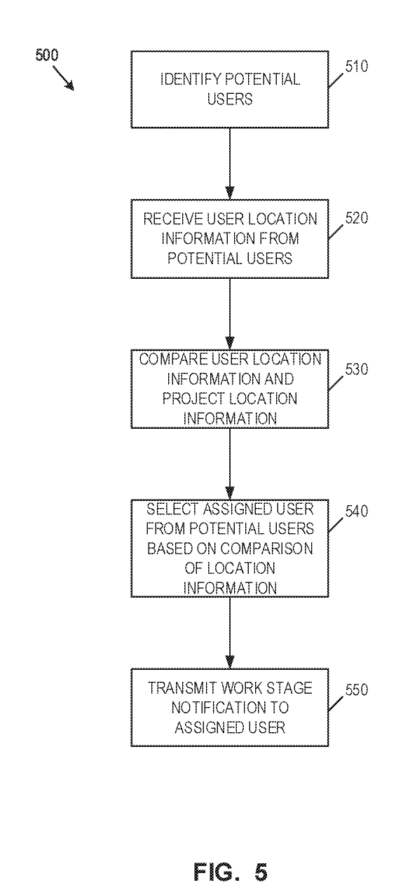

The server 120 may then select the assigned user by comparing user location information received from the user application installed on the mobile device of each potential user with the project location. For example, the server 120 may select the assigned user or users as the potential user(s) closest to the project location. In some cases, the server 120 may generate a weighted score for each potential user based on their user location information as well as other user data stored in the user profile and/or received from the user-side application 208 through the mobile device 115 of each potential user. Example processes for determining assigned users for a work stage are described in further detail below with reference to FIGS. 5, 6 and 7.

In some cases, the server 120 may determine a required number of performers for a particular work stage. The server 120 may determine the required number of performers based on the work stage completion deadline determined at 320. The server 120 may determine the number of performer hours required for a particular work stage and compare the required hours to the work stage completion deadline. The server 120 may then define the required number of performers to enable the work stage to be completed within the work stage completion deadline.

The server 120 may then assign a corresponding number of users to that work stage.

In some cases, the server 120 may adjust the required number of performers and/or work stage completion deadline based on criteria weights received from a user. For example, where the client has identified time as having a greater weight than cost, the server 120 may increase the required number of performers. Alternatively, where cost is indicated to have a greater weight than time, the work stage completion deadline may be extended while the required number of performers is reduced.

At 340, the project server 120 can transmit an assigned work stage notification to the mobile device 115 of the assigned user or users determined at 330. The assigned work stage notification can indicate that the user has been assigned to the work stage. The assigned work stage notification can also include work stage data such as the project location, the at least one task associated with that work stage and the stage completion deadline. This may provide the user with an indication of the work required and required performance period.

At 350, the server 120 can receive a work stage completion notification from the mobile device 115 of a user assigned to a work stage at 340. The work completion notification may indicate that all of the tasks required for a particular work stage have been completed. In some cases, individual task completion notifications may also be transmitted to the server 120. The server 120 may use these individual task completion notifications and work stage completion notifications to automatically update and adjust the project workflow in real-time.

In some embodiments, the server 120 may trigger a subsequent active work stage notification for the next work stage in the project timeline upon receipt of the work stage completion notification. The subsequent work stage notification can then be transmitted to a second one or more assigned users for the subsequent work stage. In some cases, the server 120 may determine the second assigned user only after receiving the first work completion notification. That is, the server 120 may determine the assigned users for subsequent work stages dynamically in response to real-time user availability and user location information.

In some embodiments, the server 120 may require a performer to transmit validation data prior to determining that a work stage is complete. The validation data may provide evidence of completion of the work stage by the user or users. The server may use this validation data to validate completion of the work stage at 360.

In some cases, the validation data may be generated automatically by the user-side application 208 installed on the user's device 115. For example, the user-side application 208 may monitor the user's location during the performance period of the work stage. This user location information can be transmitted to the server 120 as validation data to provide evidence that the user was at the project location for a particular performance period. The server 120 may compare the performance period to an expected performance period to provide a time on-site validation indicator of work stage completion.

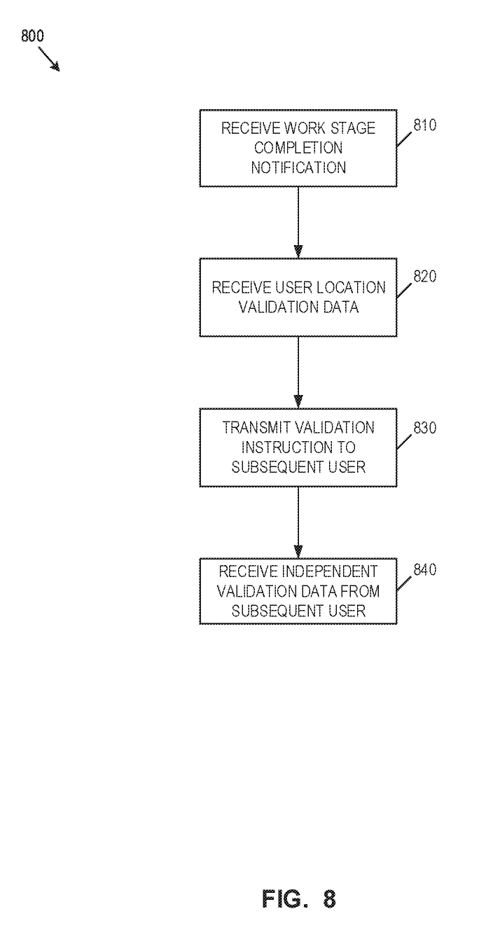

In some cases, the validation data may be generated by a user through the user application 208 on their device 115. For example, the user may capture one or more images of the completed work stage (or images of each completed tasks). The user may transmit the captured images to the server 120 as validation data indicating completion of the work stage and/or tasks. In some cases, validation data may also be independently generated by other users assigned to different work stages for the same project. An example validation process is described in further detail herein below with reference to FIG. 8.

Referring now to FIG. 4, shown therein is a flowchart illustrating a method or process 400 of generating a project workflow. Method 400 is an example of a sub-process that may be used at step 320 of method 300. Method 400 may be carried out by various components of systems 100 and 200, such as the server 120 and the user devices 115. The server 120 may generate the project workflow based on a project request received from a client device 105 as at 310 in method 300.

At 410, the server 120 can determine a plurality of work stages. The work stages can be identified based on the work defined in the project request received at 310. The work stages may be identified as the set of work stages required to complete the work defined for the project request.

For example, the project request may identify the work required as converting a separate living and dining room into an open concept combined living dining area. The server 120 may then identify a plurality of work stages, such as a demolition work stage, an electrical wiring work stage, a flooring work stage, a drywalling work stage and a painting work stage.

The work defined in the project request may also include additional work requests such as replacing windows for example. The project request may also include requested work characteristics, such as a type of flooring (e.g. hardwood vs. laminate) and colour of paint for example. The server 120 may identify additional tasks within the work stages based on the work characteristics included in the project request.

At 420, the server 120 can arrange the plurality of work stages determined at 410 into an ordered project schedule. The work stages may be arranged in the in the order in which they are required to occur. For example, demolition must occur prior to work such as wiring and drywalling, accordingly the demolition stage is ordered before other stages, such as the wiring and drywalling stages.

The ordered project schedule can include a sequence of work stages that are scheduled to occur in the defined order. The server 120 may identify dependent stage relationships between the work stages indicating that a subsequent work stage can only be initiated upon completion of one or more previous work stages. The server 120 can arrange the work stages into the ordered project schedule based on these dependent stage relationships.

For example, each subsequent stage may have a dependent relationship with the demolition stage indicating that the demolition stage is to be complete prior to initiating the wiring/drywalling/painting work stages. Similarly, the painting work stage may be dependent upon the drywalling stage being complete. The drywalling stage may, in turn, be dependent upon the wiring stage being completed etc.

In some cases, the ordered project schedule may include a plurality of schedule sub-trees. The sub-trees may be defined in parallel to one another, indicating that certain work stages may occur concurrently. For example, a window replacement stage may be dependent only on the demolition stage being complete. Thus, the window replacement stage may occur in parallel with the wiring and/or drywalling stages.

The server 120 can define the ordered project schedule based on the project timeframe. For example, where the server 120 determines that a shorter timeframe is required, additional parallel sub-trees may be defined. In other cases, where the sever 120 determines that the timeframe required is longer relative to the work required, the server 120 may omit parallel sub-trees. This may ensure that more users are available for other projects throughout the project workflow. This may also reduce the potential for errors as fewer users may be working concurrently in a confined project location.

The ordered project schedule may include a work stage completion deadline for each work stage based on this project timeframe. The work stage completion deadline may be provided to assigned users to indicate when the tasks for a particular work stage are required to be completed.

At 430, the server 120 can associate at least one required user type with each work stage identified at 410. The required user types can be associated with the work stage based on the tasks included in that work stage. In some embodiments, step 430 may occur prior to step 420. This may enable server 120 to arrange the project schedule based on the availability of users associated with the appropriate user type for the various work stages.

In some cases, multiple user types may be associated with a work stage. For example, various user types (e.g. labourer user, demolition user etc.) may be associated with work stages that require less specialized skills or certification such as the demolition stage.

In other cases, specific user types may be required where the users may be required to have specialized training or certification in order to perform the tasks required. For example, the wiring work stage may be limited to electrician user types to ensure that the user has the required training or certification.

In some cases, the server 120 can determine the project schedule based on user location information from users expected to be available during the required period. For example, where a wiring user in the vicinity of the project location 107 is unlikely to be available for one week, the reconstruction period may be extended as the subsequent wiring stage cannot be completed without a wiring user being available.

Alternatively, where a wiring user may be available in the near term, but is assigned to, or expected to be assigned to, another project in the near future, the server 120 may accelerate the schedule for the demolition stage to ensure the availability of the appropriate user for the subsequent stage. The server 120 may thus facilitate the coordination of multiple concurrent projects to provide greater likelihood of satisfying the project timeframe.

The server 120 may also dynamically update the project schedule determined at 420. For example, the server 120 may update the project schedule in response to each completion notification received indicating the completion of a work stage. When a completion notification is received, the server 120 may adjust the work completion deadline for a subsequent work stage to reflect when the work stage was actually initiated. Accordingly, the server 120 may automatically advance the completion deadline for various work stages, if possible, to account for delays that may occur during other stages of the project.

In some embodiments, the server 120 may identify assigned users for one or more work stages in advance (e.g. when the project workflow is generated). Accordingly, the server 120 may ensure that the assigned users are available for work stages in advance.

Alternatively, the server 120 may identify the assigned users for each work stage dynamically, as the work stages are initiated. This may provide a more efficient allocation of users to projects by assigning users based on current availability of both work stages and users, rather than scheduling users for expected work stages that may be delayed or start early. The server 120 can determine an expected timeline for completion of the work stage based on the real-time user location information and availability responses from potential users. The server 120 may then update the project timeline accordingly.

The server 120 may also update the project schedule continually or periodically in response to changes in user location information and/or user availability. For example, the server 120 may periodically identify potential users for upcoming work stages based on the stored user types and user location information. The server 120 may then determine the expected availability of those potential users based on their assignments to work stages on other projects and/or availability data from the mobile devices 115. The server 120 may adjust the project timeline accordingly to reflect real-time changes in the expected timeline for completion of the project and its various work stages.

In some cases, the server 120 can generate update notifications for the client user 105 associated with a project at project location 107. The server 120 may transmit update notifications indicating that the project schedule has been adjusted. In some cases, the update notifications can also include project modification criteria for the client user. The client user 105 may use the project modification criteria to adjust the work definition and/or criteria weights to account for changes in the project schedule. For example, the client user may adjust a cost weight to reduce the impact of cost on user assignments (i.e. to increase the acceptable level of costs) in order to accelerate completion of the project. Accordingly, the server 120 may then determine that additional users, or more costly users who perform more rapidly, should be assigned to the subsequent work stages.

Referring now to FIG. 5, shown therein is a flowchart illustrating a method or process 500 of determining an assigned user for a work stage. Method 500 is an example of a sub-process that may be used at step 330 of method 300. Method 500 may be carried out by various components of systems 100 and 200, such as the server 120 and the user devices 115.

At 510, the server 120 can identify at least one potential user for a particular work stage. The server 120 can identify the potential users by comparing the required user types for the work stage with the user types stored in the user profiles in database 232. Users whose user profiles have an associated user type that corresponds to one of the required user types for the work stage can be identified as a potential user.

At 520, the server 120 can receive user location information from the potential users identified at 510. The user location information can be generated by the user-side application 208 on mobile devices 115. The user location information can identify the current (i.e. real-time) location of the corresponding user. This may allow the server 120 to identify the potential users who are located nearby to the project location 107 for which the work stage assignment is being performed.

In some cases, the server 120 may apply an initial geographic filter when identifying the potential users at 510. The server 120 may use the geographic region information stored in the user profiles to identify the potential users from only users who perform within a geographic region that is within a defined vicinity (e.g. 10 km, 25 km, 50 km etc.) of the project location 107.

At 530, the server 120 can compare the project location 107 and the user location information received from the potential users at 520. At 540, the server 120 can select one or more assigned users based on the comparison of the project location 107 and user location information from 530.

In some cases, the server 120 may define a vicinity score for each potential user. For example, the server 120 may arrange the potential users into a listing of nearby potential users. The listing of nearby potential users may rank the potential users 115 based on their vicinity to the project location 107, and assign higher scores to the potential users ranked highest. The server 120 may then select the assigned users as the nearest potential users using the ranked listing of nearby potential users.

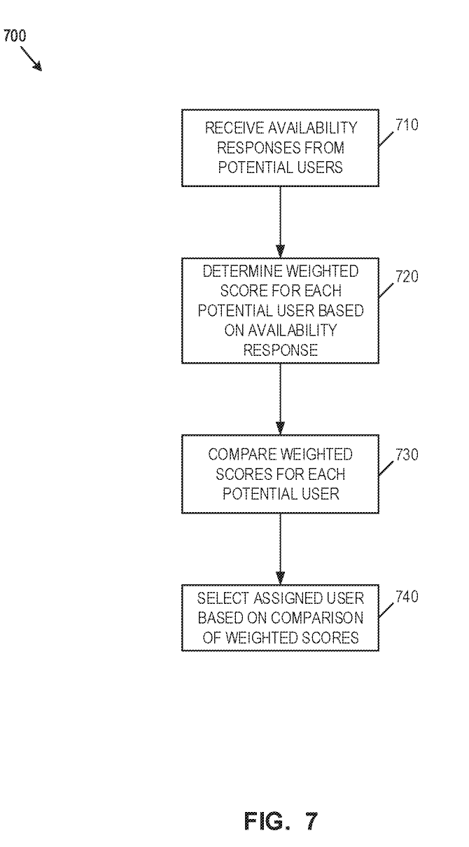

In some cases, the server 120 may use the vicinity score in combination with other user-specific factors (e.g. availability, cost, previous ratings etc.) to generate a weighted score for each potential user. The server 120 can use the weighted score to automatically assign users with the highest weighted score to the work stage. An example process of selecting assigned users based using a weighted score is described in further detail below with reference to FIG. 7.

At 550, the server 120 can transmit an assigned work stage notification to the mobile device 115 of the assigned user or users through the user-side application 208. The assigned work stage notification can indicate that the user has been assigned to the work stage. The assigned work stage notification can also include work stage data such as the project location 107, the at least one task associated with that work stage and the stage completion deadline for example.

In some cases, the server 120 may also use availability data from the potential users to select the assigned users. The server 120 may determine projected availability data for each potential user based on current work stage assignments for the projects scheduled by server 120. The server 120 may also determine expected future assignments for each potential user based on the project workflows for other multi-stage projects scheduled by server 120. In some cases, the server 120 may limit the potential users to only those users that are available, or expected to be available, to complete the tasks associated with a work stage ahead of the work stage completion deadline.

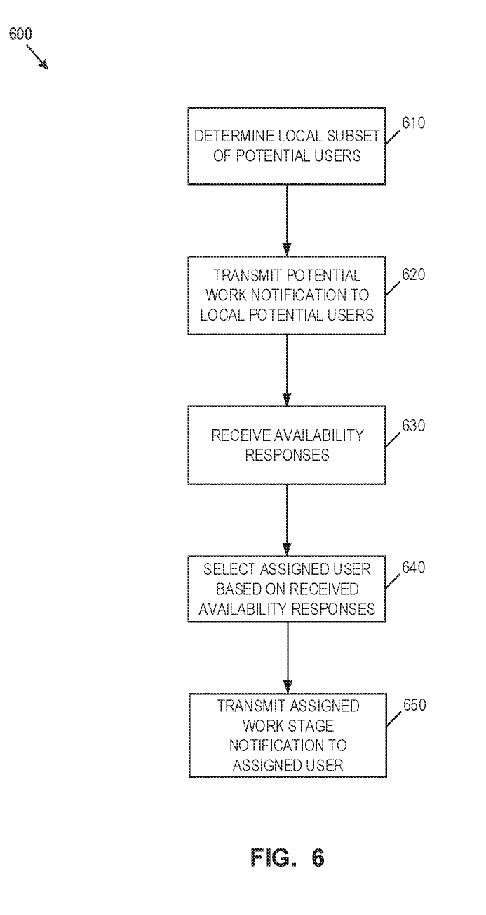

Referring now to FIG. 6, shown therein is a flowchart illustrating a method or process 600 of determining an assigned user for a work stage. Method 600 is another example of a sub-process that may be used at step 330 of method 300. Method 600 may be carried out by various components of systems 100 and 200, such as the server 120 and the user devices 115.

At 610, the server 120 can determine a local subset of potential users by comparing the project location 107 to location information received from the user application 208 on the mobile devices 115 of each potential user. The location information can indicate a current location of the mobile device 115. The server 120 may identify the local potential users as users whose user location is within a local threshold proximity (e.g. less than 10 km, less than 25 km) of the project location 107.

In some cases, the local threshold proximity may be determined based on an expected time required for the user of mobile device 115 to travel to and from the project location 107. Depending on the work stage for which the server 120 is determining assigned users the local threshold proximity may change. For example, if the work stage has a shorter completion deadline (indicating that the work stage is to be completed more rapidly) such as hours or 1-2 days, the local threshold proximity may smaller so that only users in closer proximity to project location 107 are identified as local potential users as their travel time to the project location 107 is less. For work stages with longer completion deadlines, the local threshold proximity may be expanded so that there is a greater likelihood of identifying available, potential users. In such cases, the travel time to the project location 107 may have less of an impact on the work stage duration than the specific users available (e.g. more users or faster users).

At 620, the server 120 can transmit a potential work stage notification to each local potential user identified at 610. Each local potential user may receive the potential work stage notification through the user application 208 on their mobile device 115. The potential work stage notification can indicate to the potential user that a work stage is upcoming (i.e. about to be initiated). The potential work stage notification may also request an availability response from the potential user reflecting their availability for the work stage.

The potential work stage notification may include initial work stage data, such as a work stage summary and the work stage completion deadline. The potential work stage notification may also include a general vicinity of the project location 107. In some cases, the potential work stage notification may omit some details of the work stage data, such as the project location 107 itself and/or specific tasks required. This may provide the client with privacy and security by only transmitting the project location 107 to users who have accepted a work stage assignment.

The potential work stage notification may omit specific task details in some cases, and instead provide a general work stage description, work stage timing and expected work stage duration. The specific tasks required may be hidden until the work stage is assigned to a user (and the user has accepted the assignment). This may encourage users to indicate their availability by preventing users from disregarding more difficult work stages.

At 630, the server 120 can receive at least one availability response from the local potential users. Each availability response can be received from the user application 208 on the mobile device 115 of one of the local potential users. The availability response may indicate that the corresponding local potential user is available to perform the tasks associated with the work stage. In some cases, the availability response may indicate that the corresponding local potential user is only available during a certain period to perform the tasks associated with the work stage. The availability response may also indicate that the corresponding local potential user is not available.

At 640, the server 120 can select the assigned user from amongst the available local potential users. The server 120 may identify the available local potential users from the availability responses received at 630. The server 120 may identify a potential user as being available if the availability response indicates that the potential user will be available for a sufficient period to perform the tasks associated with the work stage ahead of the work completion deadline.

In some examples, the availability response received from users may include further availability data, such as expected costs to perform the task. This additional availability data can be defined by users through the user-side application 208 on mobile device 115. Users may define the availability data to increase the likelihood of being assigned a particular work stage, for instance by providing a reduced cost estimate.

The server 120 may use the availability data received, as well as data stored in the user profiles on database 232 to generate a weighted score for each potential user. The server 120 may then assign work stages based on this weighted score. An example process for selecting assigned users using a weighted score is described in further detail below with reference to FIG. 7.

At 650, the server 120 can transmit an assigned work stage notification to the mobile device 115 of the assigned user or users selected at 640. The assigned work stage notification can include work stage data, such as the project location 107, work required, work stage completion deadline etc. The assigned work stage notification may include information that was omitted from the potential work notification, such as the specific project location 107 and specific tasks required for the work stage.

Method 600 is an example of a process that may be used to dynamically assign a work stage to one or more users. In some cases, method 600 may be initiated in response to receiving a work stage completion notification for a previous stage, as at step 350 of method 300. The server 120 may then perform method 600 to identify available local potential users based on real-time location and availability data. This may provide the system 100 with flexibility to select assigned users based on up to date location and availability data. This may ensure that suitable users are assigned to work stages as they become available, which may speed up the process of the work stage being performed and provide an efficient allocation of work stages. For instance, in some embodiments, the server 120 may select the assigned user(s) from the first user(s) to respond to the potential work stage notification.

In some cases, the potential work stage notification may include an availability response deadline. The availability response deadline may provide a defined period within which potential users must provide an availability response to be considered by the server 120 for assignment of the work stage.

Referring now to FIG. 7, shown therein is a flowchart illustrating a method or process 700 of selecting an assigned user. Method 700 is an example of a sub-process that may be used at step 330 of method 300, step 540 of method 500, and/or step 640 of method 600. Method 700 may be carried out by various components of systems 100 and 200, such as the server 120 and the user devices 115.

At 710, the server 120 can receive at least one availability response from a potential user indicating availability for a potential work stage. The availability response may be generated in response to a potential work stage notification, such as that transmitted at 620. A user may select the potential work stage notification on the user-side application 208 on their mobile device 115. The performer may then input their availability response in response to the potential work stage notification.

In some cases, the potential work stage notification may include a plurality of work stage response criteria for the user to input. For example, each availability response may be required to include a proposed cost and a proposed completion time for the particular work stage. The user-side application 208 may provide a fillable form or input GUI to the user on the mobile device 115. In order to generate the availability response, the user of mobile device 115 can provide the requested availability data using the required response criteria fields.

A user may input the proposed cost and proposed completion time based on the work stage data included in the potential work stage notification. The potential work stage notification may include an estimate of time required. The user may then base their proposed cost and completion time on the estimate of time required, work definition and the project location 107. Users may also adjust their proposed cost and proposed completion time to provide a competitive bidding process for a particular work stage.

At 720, the server 120 can determine a weighted score for each potential user. The weighted score may include a plurality of weighting criteria, such as a timing weight, a cost weight, and a quality weight. Each weighting criteria may be assigned a criteria weight that is used to generate an overall score for the potential user.

The server 120 may evaluate one or more of the weighting criteria based on user data stored in the user profiles on database 232, such as previous user-generated scores or ratings. The server 120 may also evaluate one or more weighting criteria based on availability data received from the availability responses received at 710.

In some cases, a work stage may include a plurality of user types that may be suitable for that work stage. The weighting criteria may then include a user type match score for each potential user. The server 120 may determine the user type match score (e.g. a match or relevance score) for the user types associated with each potential user and the particular work stage.

In some cases, the client user 105 may define the criteria weights as part of the project request transmitted to the server 120. This may allow the client user 105 to adjust the weighting score based on factors that are more important to that particular client user, such as time vs. cost, by increasing the criteria weight of more important factors. In some cases, the client user 105 may update the criteria weights as the project is ongoing. The client user 105 may update the criteria weights in response to update notifications received from the server 120.

Alternatively, the server 120 may define a default set of criteria weights. The default set of criteria weights may be defined to provide an optimized weighting of factors that balances the various weighting criteria. In some cases, the server 120 can monitor client-selected criteria weights for a plurality of projects on an ongoing basis. The server 120 may dynamically adjust the default set of criteria weights based on an average set of criteria weights from the monitored client-selected criteria weights. This may further improve the initial weighted score to reflect changes in client preferences.

The server 120 may determine a weighted user score for each potential user by applying the set of criteria weights to the availability data from the availability response. In some cases, the availability data for each weighting criteria may be normalized to provide a consistent basis for generating a score across all the criteria. For example, the user availability data received from multiple potential users may be ranked in each weighting criteria. The criteria weights may then be applied based on the potential user's ranking in a particular category.

In some cases, the server 120 may determine a distribution of availability data in each weighting category. For example, the server 120 may determine, for each potential user, a standard deviation of their availability data from the average availability data in that weighting criteria. The server 120 may then use this standard deviation to provide a normalized score that is weighted by the corresponding criteria weight.

At 730, the weighted scores generated for each potential user can be compared by the server 120. At 740, the assigned user can be selected as the local potential user having the highest weighted score.

In some cases, the weighted scores for a subset of potential users (e.g. 3 or 5 potential users for example) may be displayed to the client user 105. The client user 105 may then select the assigned user or users from the subset of potential users using the user-side application 208. The client user 105 may also be permitted to review user data for the subset of potential users, such as written reviews stored in the user profiles in database 232.

Referring now to FIG. 8, shown therein is a flowchart illustrating a method or process 800 of validation a work stage completion. Method 800 is an example of a sub-process that may be used at step 360 of method 300. Method 800 may be carried out by various components of systems 100 and 200, such as the server 120 and the user devices 115.

At 810, the server 120 can receive a work completion notification from the mobile device 115 of a user assigned to a particular work stage as described above at step 350 of method 300. The server 120 may then determine that the work stage is provisionally completed.

To ensure that the work stage has been completed successfully, the server 120 may validate the work stage completion. In some cases, the validation process may be implemented for each work stage. In some cases, individual aspects of the validation process may be implemented for each work stage, while other aspects (e.g. independent validation) may be implemented only intermittently or randomly.

At 820, the server 120 can receive validation data corresponding to the work stage completed at 810. The validation data may provide evidence of completion of the work stage by the assigned user. In some cases, the server 120 may determine that the work stage is completed only after receipt of the validation data for the work stage. Accordingly, in some cases the server 120 may delay initiation of a subsequent work stage until the validation data is received. The server 120 may also delay any payments to a user assigned to a particular work stage until after that work stage has been validated. This may provide an added incentive to users to provide the validation data rapidly.

The validation data may include one or more validity indicators, each of which may be required to validate completion of the work stage. In some cases, some or all of the validation data may be contained within the work stage completion notification transmitted by the user assigned to a work stage. In other cases, the validation data may be generated subsequently and/or by other users independent of the assigned user.

In some cases, the validation data may be generated by an assigned user using user-side application 208. For example, the server 120 may include in the work stage notification one or more validation instructions for that work stage. The validation instructions may indicate validation data to be collected by that user. The user may then access user-side application 208 to generate the required validation data.

For example, the validation data may include images of the completed tasks. The user may capture the image validation data using camera 216 on mobile device 115. The user-side application 208 may tag the image validation data using location information, such as GPS or cellular location data to ensure that they are generated at the project location 107. The user-side application 208 may also timestamp the image validation data to ensure that it was captured subsequent to the work stage completion. The user can then transmit the validation data to server 120 using the user-side application 208. In some embodiments, the validation data may be captured while the user-side application 208 is in live communication with the server 120 (e.g. a data stream) to ensure that the validation data is proper.

In some cases, the server 120 may transmit the validation instructions in real-time in response to the work stage completion notification. The assigned user may then have a validation period within which to capture and transmit the validation data. This may further guard against an assigned user capturing images from other projects, by providing a limited time frame within which to capture the validation data (and by only identifying the validation data required after work stage completion).

In some cases, the user side application 208 can be configured to automatically generate validation data for a work stage. For example, the user-side application may be configured to generate validation data on an ongoing basis while a user is assigned to a work stage. The user-side application 208 may monitor user location information during the period for which that user is assigned to a work stage. This user location information can then be transmitted to server 120. The server 120 may then determine an on-location time period for the assigned user based on the received user location information. The server 120 may compare the on-location time period to an estimated work stage period to provide an on-site time validity indicator.

In some cases, the server 120 may also require independent validation by a user not assigned to the work stage. For example, the server 120 may include validation instructions in the work stage notification transmitted to a user assigned to the subsequent work stage.

At 830, the server 120 can transmit the validation instruction for a second assigned user in the work stage notification for a subsequent work stage. The validation instruction can define a validation task for the second assigned user to generate independent validation data indicating completion of the first work stage. For example, the validation instructions may indicate one or more images for the second assigned user to capture in respect of the previous work stage.

This subsequent user can review the validation instructions and generate the requested validation data using the user-side application 208. The subsequent user may generate the request validation data in the same manner as described above at 830. The requested validation data can then be transmitted to server 120 as part of the validation data for the previous work stage.

At 840, the server 120 can receive the independent validation data from the second assigned user through the user-side application 208. The server 120 may then determine that the work stage is completed upon receipt of the independent validation data.

Referring now to FIG. 9, shown therein is a flowchart illustrating a method or process 900 of generating a project request. Method 900 is an example of a sub-process that may be used at, for example, step 310 of method 300. Method 900 may be carried out by various components of systems 100 and 200, such as the server 120 and the user devices 115.

At 910, the server 120 may provide a project request template for a client user 105. The client user 105 may access the project request template through the user-side application 208 and/or through an online portal.

The server 120 may define a plurality of project criteria fields in the project request template. Examples of project criteria fields can include a project start date, a project end date (or project timeframe), work required (e.g. a drop-down list of work categories), and cost range. The work required may also further include quality restrictions. For example, each work category selected by the user may include one or more quality options to be selected by that user (e.g. hardwood flooring, vs. manufactured hardwood, vs. laminate etc.).

At 920, the server 120 can receive a selection of initial project criteria from the client user. The initial project criteria can be defined by the user through the project request template. The initial project criteria may also include an initial set of criteria weights for the project.

At 930, the server 120 can generate a potential project workflow using the initial project criteria. The potential project workflow may be generated in a manner similar to that described above in method 400.

The server 120 can generate the potential project workflow based on user location information and user availability data from users 115. For example, the server 120 may estimate user availability for the potential project workflow using user assignments in other, unrelated projects currently scheduled by the server 120.

The server 120 may also monitor the real-time status of other projects, such as dynamic changes to those project workflows to determine the potential project workflow. In some cases, the server 120 may adjust the expected cost based on a reduced availability of one or more user types required for the initial project criteria.

The server 120 may then generate an estimated project timeline and estimated project cost based on the user location information and user availability data. At 940, the estimated project timeline and estimated project cost can be displayed to the client user 105 through user-side application 208 or through the online portal. The server 120 may also generate one or more alternative criteria and a corresponding adjustment to the project timeline and or project cost that the server 120 estimates would occur if that alternative criterion is selected.

The client user 208 may then adjust one or more of the initial project criteria. For instance, the client user 208 may select one of the alternative criteria presented by the server 120. Alternatively, the client user 208 may use the project request template to adjust any of the initial project criteria selected. The server 120 may then automatically modify the estimated timeline and/or estimated cost based on the adjusted project criteria.

In some cases, the server 120 may also display to the client a plurality of optimized projects based on defined criteria weights. For example, the server 120 may determine alternative project criteria that are selected based on the minimal cost or fastest completion deadline. This may reflect the expected project workflow if the client were to indicate that cost had the greatest criteria weight or time had the greatest criteria weight respectively.

In some cases, the server 120 may also provide alternative project criteria based on the expected availability of users during the expected project timeline. For example, the server 120 may indicate that one or more work requests may be modified in order to satisfy the expected project timeline. For example, no nearby users with hardwood flooring user type are available during the expected project timeline, although users with laminate flooring user type or carpet user type are available. Accordingly, the server 120 may indicate laminate flooring and/or carpet flooring as an alternative criteria.

At 950, the server 120 can receive a selection of the final project criteria as the project request. The server 120 may then use the final project criteria to generate a project workflow and initiate the project as described herein above.

The server 120 may also provide real-time update notifications indicating that project has deviated from the expected timeline (either delayed or advanced). The server 120 may also provide an updated cost estimate and/or timeline in the real-time notifications. The client user 105 may then select one or more project criteria to adjust in response to the update notifications, in a manner similar to selecting the final project criteria.

The client user 105 may adjust the project criteria as the project is ongoing, in response to these update notifications, or merely in response to a change in the desired project result. In embodiments where the server 120 assigns users to work stages dynamically, in real-time, the modified project criteria may minimal impact the assignment of users to work stages in the modified project and other projects scheduled by server 120.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

We claim:

1. A system for automatically scheduling tasks for multi-stage projects, the system comprising:
a task scheduling server comprising a memory and a server processor coupled to the memory, the task scheduling server in communication with a plurality of mobile devices, each mobile device associated with a user having a user profile stored in the memory of the task scheduling server wherein each user profile has at least one associated user type; and
a user application installed on each of the mobile devices;
wherein the processor of the task scheduling server is configured to:
receive a project request identifying a plurality of project criteria, the plurality of project criteria including a project location, a project timeframe and a work definition;
generate a project workflow from the plurality of project criteria, the project workflow including a plurality of work stages required to complete the work requested and a work stage completion deadline determined based on the project timeframe, wherein each work stage includes at least one task;
associate at least one required user type with each work stage based on the tasks included in that work stage;
for each work stage,
determine an assigned user by:
identifying at least one potential user as a user whose user profile has an associated user type that corresponds to one of the required user types for the work stage; and
selecting the assigned user from the at least one potential users based on a comparison of the project location and user location information received from the user application installed on the mobile device of each potential user; and
transmit an assigned work stage notification to the mobile device of the assigned user through the user application, the assigned work stage notification indicating that the user has been assigned to the work stage and including work stage data indicating the project location, the at least one task associated with that work stage and the stage completion deadline.

2. The system of claim 1, wherein
the processor of the task scheduling server is configured to:
arrange the plurality of work stages into an ordered project schedule that is defined in accordance with the project timeframe, the ordered project schedule including a plurality of dependent stage relationships, each dependent stage relationships indicating that initiation of a second work stage is dependent upon at least partial completion of a first work stage;
receive a first work completion notification from the mobile device of a first assigned user for the first work stage through the user application; and
trigger transmission of the work stage notification to a second assigned user for the second work stage in response to the work completion notification.

3. The system of claim 2, wherein the second assigned user is determined after receiving the first work completion notification.

4. The system of any one of claims 2 and 3, wherein
the processor of the task scheduling server is configured to:
receive validation data corresponding to the first work stage, the validation data providing evidence of completion of the first work stage by the first assigned user; and
indicate that the first work stage is completed only after receipt of the validation data for the first work stage.

5. The system of claim 4, wherein the user application includes instructions for configuring the processor of the mobile device of the first assigned user to:
automatically monitor a location of the first assigned user during the first work stage to generate first user location data; and
the validation data includes the first user location data.

6. The system of any one of claims 4 and 5, wherein the validation data further comprises image data received from the mobile device of the first assigned user.

7. The system of any one of claims 2 to 6, wherein:
the work stage notification for the second work stage further includes a validation instruction for the second assigned user, the validation instruction defining a validation task for the second assigned user to generate independent validation data indicating completion of the first work stage; and
the processor of the task scheduling server is configured to receive the independent validation data from the second assigned user through the user application.

8. The system of any one of claims 1 to 7, wherein the processor of the task scheduling server is configured to select the assigned user for a particular work stage by:
determining a local subset of the potential users by comparing the project location to location information received from the user application installed on the mobile device of each potential user, the local subset including a plurality of local potential users with each local potential user having a user location that is within a local threshold proximity of the project location;
transmitting a potential work stage notification to each local potential user;
receiving at least one availability response, each availability response received from the user application on the mobile device of one of the local potential users and indicating that the corresponding local potential user is available; and
selecting the assigned user from amongst the available local potential users.

9. The system of claim 8, wherein:
the plurality of project criteria include a plurality of weighting criteria, the plurality of weighting criteria including a timing weight, a cost weight, and a quality weight;
each availability response includes a proposed cost and a proposed completion time for the particular work stage; and
the processor of the task scheduling server is configured to select the assigned user by:
determining, for each local potential user, a weighted user score based on the proposed cost, the proposed completion time, and user quality data stored in the user profile for that local potential user using the plurality of weighting criteria; and
selecting the assigned user as the local potential user having the highest weighted score.

10. The system of any one of claims 1 to 9, wherein the assigned user for each work stage is selected from the at least one potential users based on projected availability data associated with the potential users, the projected availability data determined based on the project workflows for a plurality of unrelated multi-stage home renovation projects scheduled by the server.

11. A method of automatically scheduling tasks for multi-stage projects, the method comprising:
providing a task scheduling server in communication with a plurality of mobile devices;
storing, for each mobile device, a user profile associated with a user, the user profile including at least one associated user type;
providing a user application for installation on each of the mobile devices;
receiving, by the server, a project request identifying a plurality of project criteria, the plurality of project criteria including a project location, a project timeframe and a work definition;
generating, by the server, a project workflow from the plurality of project criteria, the project workflow including a plurality of work stages required to complete the work requested and a work stage completion deadline determined based on the project timeframe, wherein each work stage includes at least one task;
associating, by the server, at least one required user type with each work stage based on the tasks included in that work stage;
for each work stage,
determining, by the server, an assigned user by:
identifying at least one potential user as a user whose user profile has an associated user type that corresponds to one of the required user types for the work stage; and
selecting the assigned user from the at least one potential users based on a comparison of the project location and user location information received from the user application installed on the mobile device of each potential user; and
transmitting, by the server, an assigned work stage notification to the mobile device of the assigned user through the user application, the assigned work stage notification indicating that the user has been assigned to the work stage and including work stage data indicating the project location, the at least one task associated with that work stage and the stage completion deadline.

12. The method of claim 11, further comprising
arranging, by the server, the plurality of work stages into an ordered project schedule that is defined in accordance with the project timeframe, the ordered project schedule including a plurality of dependent stage relationships, each dependent stage relationships indicating that initiation of a second work stage is dependent upon at least partial completion of a first work stage;
receiving, by the server, a first work completion notification from the mobile device of a first assigned user for the first work stage through the user application; and
triggering transmission of the work stage notification to a second assigned user for the second work stage in response to the work completion notification.

13. The method of claim 12, wherein the server determines the second assigned user after receiving the first work completion notification.

14. The method of any one of claims 12 and 13, further comprising:
receiving, by the server, validation data corresponding to the first work stage, the validation data providing evidence of completion of the first work stage by the first assigned user; and
indicating that the first work stage is completed only after receipt of the validation data for the first work stage.

15. The method of claim 14, further comprising:
automatically monitoring by the user application a location of the mobile device of the first assigned user during the first work stage to generate first user location data; and
receiving, by the server as part of the validation data for the first work stage, the first user location data from the user application.

16. The method of any one of claims 14 and 15, further comprising receiving, by the server, image data from the mobile device of the first assigned user as part of the validation data.

17. The method of any one of claims 12 to 16, further comprising
transmitting, by the server, a validation instruction for the second assigned user in the work stage notification for the second work stage further, the validation instruction defining a validation task for the second assigned user to generate independent validation data indicating completion of the first work stage; and
receiving, by the server, the independent validation data from the second assigned user through the user application.

18. The method of any one of claims 12 to 16, wherein the assigned user for a particular work stage is selected by the server by:
determining a local subset of the potential users by comparing the project location to location information received from the user application installed on the mobile device of each potential user, the local subset including a plurality of local potential users with each local potential user having a user location that is within a local threshold proximity of the project location;
transmitting a potential work stage notification to each local potential user;
receiving at least one availability response, each availability response received from the user application on the mobile device of one of the local potential users and indicating that the corresponding local potential user is available; and
selecting the assigned user from amongst the available local potential users.

19. The method of claim 18, wherein:
the plurality of project criteria include a plurality of weighting criteria, the plurality of weighting criteria including a timing weight, a cost weight, and a quality weight;
each availability response includes a proposed cost and a proposed completion time for the particular work stage; and
the assigned user is selected by the server by:
determining, for each local potential user, a weighted user score based on the proposed cost, the proposed completion time, and user quality data stored in the user profile for that local potential user using the plurality of weighting criteria; and
selecting the assigned user as the local potential user having the highest weighted score.

20. The method of any one of claims 11 to 19, wherein the assigned user for each work stage is selected by the server from the at least one potential users based on projected availability data associated with the potential users, the projected availability data determined based on the project workflows for a plurality of unrelated multi-stage home renovation projects scheduled by the server.
